(19) United States
(12) Patent Application Publication
(10) Pub. No.: US 2005/0086062 A1
(43) Pub. Date: Apr. 21, 2005

(54) Monitoring of network usage

(76) Inventors: Jonathan A Clark, Ipswich Suffolk (GB); Alexios Tsiaparas, Nea Anyrni (GB)

Correspondence Address: NIXON & VANDERHYE, PC, 1100 N GLEBE ROAD, 8TH FLOOR, ARLINGTON, VA, 22201-4714, US

(21) Appl. No.: 10/501,779

(22) PCT Filed: Jan. 16, 2003
(86) PCT No.: PCT/GB03/00188

(30) Foreign Application Priority Data
Jan. 28, 2002 (EP) 022505606

(51) Int. Cl. G06F 17/60

(52) U.S. Cl. 705/1; 705/34

(57) ABSTRACT

A bandwidth-on-demand network records connections established by a user (1), and also records calls made by that user using a specific application controller (4) controlling a peer-to-peer file transfer system. Calls may then be charged by a billing engine (7) at different rates according to whether a connection make use of the application (4). The application server (4) monitors the use made of files transferred over the system and charges payments according to the nature of the files, for example to extract royalty payments. By charging a high premium for peer-to-peer transfers made other than to an approved application server (4), uncontrolled and unsupervised file transfers can be discouraged, thereby reducing the uncontrolled exchange of copyright material.

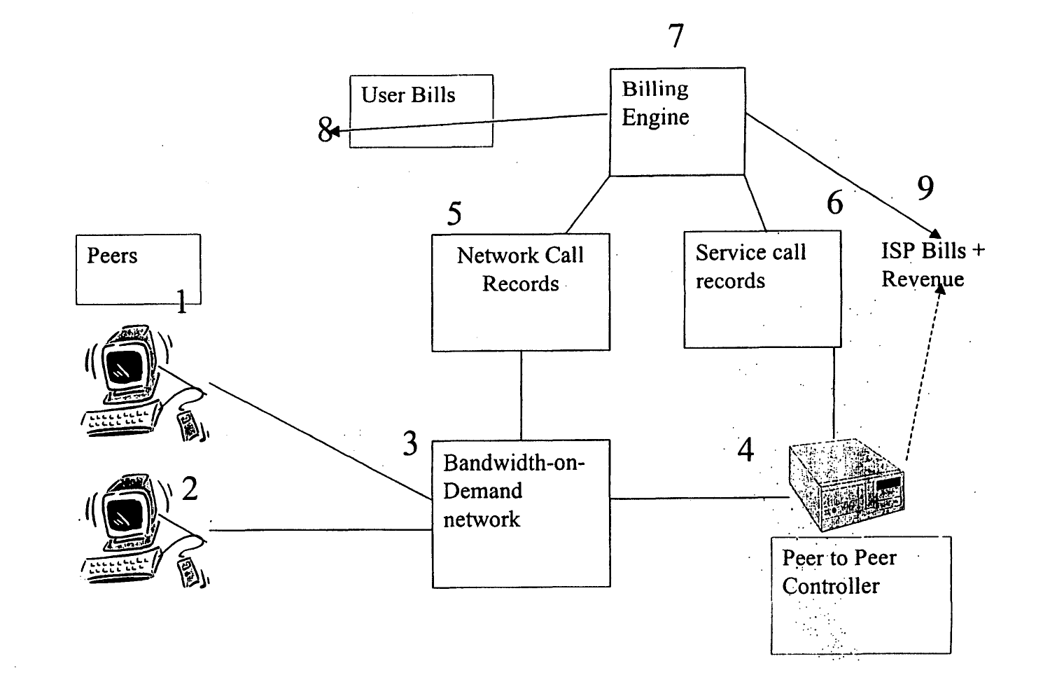

This invention relates to apparatus for monitoring the use made by customers of a telecommunications system. The principal use of such apparatus is for determining charges to be made for the use of the telecommunications system, and such apparatus when used for this purpose is sometimes referred to as a “billing engine”. Other uses include market analysis and network planning. Billing engines may generate actual paper-based or electronic bills for subsequent payment by the customer, or they may control an automated electronic funds transfer system. The present invention relates in particular to a billing engine for use with a “bandwidth-on-demand” system, in particular to assist the regulation of “peer-to-peer” file sharing systems.

Users of telecommunications systems require sufficient bandwidth to be available to them to run the fastest-running application they may wish to use. However, for many other applications run by the same user, this bandwidth may be far more than necessary. A bandwidth-on-demand system allows a user to select the capacity (bit-rate) he requires for a particular application, and pay a tariff according to the network capacity used. Thus a user will pay a higher rate when he is using a 4 Mbit/second connection than when he is using a 2 Mbit/second connection. This is to the mutual benefit of the user and the service provider, as the customer only pays for the network capacity he requires, and the capacity thus released is available for other customers to use.

“Peer-to-peer” processing is the sharing of computer resources and services by direct exchange between systems. Resources range from information and processing cycles, to remote disk storage for files. Peer-to-peer processing enables the clients to communicate directly among themselves, thus acting both as clients and servers, assuming the most efficient role in the network. This direct exchange reduces the load on dedicated servers, allowing them to concentrate on specialised services.

Peer-to-peer systems enable the operation of servers with no systems administration. Users with little computing background can use the systems to share resources, unlike Client/server systems which require administration to operate and secure the servers. On the other hand, client/server systems are more efficient than Peer-to-peer systems, because they use specialised hardware and connections to operate, whereas Peer-to-peer systems operate on normal Personal Computers. However, client/server systems are also more expensive, as they need to be engineered for 100% reliability and peak loads.

Two basic types of Peer-to-peer systems exist. “Pure” Peer-to-peer systems allow direct communication between peer systems (users). “Indexed” Peer-to-peer systems require an index server which stores the addresses of users (“Peers”) to provide the connection. This category of peer-to-peer system is more controllable as all users need to access the index server. The present invention makes use of an indexed system.

There are a number of security issues associated with Peer-to-peer systems. Securing a single server is a major task, usually undertaken by highly trained personnel. Peer-to-peer systems, without dedicated system administrators, do not provide the same levels of security.

Peer-to-peer computing has encouraged the sharing of user content among the multitude of people that use such applications worldwide. In particular, file-sharing programs enable users to freely share files containing entertainment content, such as music, video, and games. This has put network operators and service providers in a difficult legal position as they are under pressure from the owners of the intellectual property in that content to shut down or limit access to such applications, as the majority of users are making these files available without their consent.

Most attempts to prevent copyright infringement rely on Digital Rights Management (DRM)—encryption of the contents so that only authorised users can use them. However, with the ease with which people can create their own digital versions, this is only a partial solution. Even if digitised content can be made secure, there is a lot of unsecured content that is already stored on privately-owned video cassettes and DVDs, which could be readily digitised and made available if a suitable distribution medium existed.

The peer-to-peer system makes available far more content than broadcast networks could hope to provide, and at a far cheaper cost. Unfortunately the likely end result will be the network operators and Internet Service providers (ISPs) embroiled in legal action from the content owners, trying to get them to remove offending users from the network, or high churn as ISPs cut off offenders who then just join another ISP. Also, the very expensive content systems that are being put in place by such operators could simply be bypassed, users instead accessing free content from other end users.

The copyright owners may, with the co-operation of the ISPs, monitor the most popular peer-to-peer systems and identify the users who are most active or have the most valuable content, and take legal action against the user of the relevant IP address, but the process is complex and reactive. However, such action is likely to be of little real benefit to the copyright owner as in many cases the perpetrator is a private individual, with insufficient assets from which the copyright owner could recover damages. The monitoring and legal processes also distract network operators, Internet Service Providers (ISPs) and the authorised content distributors (the movie industry) from their main businesses.

There is therefore a need to provide a network that encourages legal peer-to-peer trading, such that revenue can be directed to the appropriate content owner. One way to discourage illegal video trading would be to arrange the network such that illegal trading is very much more inconvenient or expensive than the legal alternative.

It is thought that peer-to-peer music sharing systems were responsible for a significant part of the growth in demand for higher bandwidth systems such as ADSL (asynchronous digitial services link). A typical music track a few minutes in duration would take about 30 minutes to download on a standard 56 kbit/s narrowband link, but less than one minute on a 2 Mbit/s link. Downloading music is therefore possible on narrowband, although the music cannot be listened to in real time.

For transfer of data with a high information content, such as motion pictures, existing narrow band connections are much less suitable because of the length of time needed to download the information. Videos have a much greater information content than audio tracks, and are usually longer in duration as well, so they would take several hours to download on a narrowband link. To download a 650 MB movie over a 128 kb/s link would take nearly twelve hours. In most cases it would be more convenient, and certainly faster, to obtain the movie by visiting a video rental shop to hire the movie for a small fee. To download a video in a time comparable with its running time, so that it can be watched more or less in real time as it is downloaded, requires the use of higher bandwidth links. Restricting the bandwidth available to a user would discourage the transfer of such data, so that only the most dedicated user would be tempted to use pirated movies. However, there is likely to be little demand for a broadband Internet connection system that offers rates only a little faster than existing dial-up services. Therefore the service would need to include a bandwidth-on-demand capability to provide end users with more bandwidth when they need it, on a “pay as you go” basis.

Bandwidth-on-demand networks that charge for bandwidth or data rate usage generally charge all users the same tariff for a given bandwidth, but it wouled be possible to provide differential tariffs to collect any royalties due. However, there is no financial incentive for a private individual to require such a premium rate to be paid for transfer of content on the “peer to peer” system, since it is a third party (the copyright owner) who would benefit. Differential tariffs according to content value are therefore not generally possible with existing systems. Dishonest end users and application developers could simply disguise their applications in order to attract lower tariffs than they should. Similar considerations apply to other applications that require high network quality of service. The present invention does not physically prevent such subterfuges, but seeks instead to discourage them by making them prohibitively expensive or inconvenient.

According to the invention, there is provided apparatus for monitoring the use of a bandwidth-on-demand network, comprising first recording means for recording connections established on the network, an application server controlling use of a specified application, the application server having second recording means for recording calls made on the network using that application, and a monitoring device for receiving inputs from the first and second recording means, and generating an output according to said inputs.

According to another aspect, there is provided a usage-monitoring process for a bandwidth-on-demand network, wherein connections established on the network are recorded, and an application server controlling use of a specified application also records calls made on the network using that application, and an output is generated according to which connections make use of that application.

As has already been indicated, the invention may be used to generate billing information, according to the inputs from the recording means.

Accordingly the invention also provides a billing process for a bandwidth-on-demand network, wherein a billing system records connections established on the network, and an application server controlling use of a specified application also records calls made on the network using that application, and instructs a billing engine which connections made use of that application, and wherein such calls are charged by the billing engine at different rates according to whether those connections make use of that application.

According to a further aspect, there is provided a billing system for a bandwidth-on-demand network, comprising first recording means for recording connections established on the network, an application server controlling use of a specified application, the application server having second recording means for recording calls made on the network using that application, and a billing engine for receiving inputs from the first and second recording means, and for generating charges for calls at different rates according to said inputs.

The invention provides a system that puts the onus on an application developer or service provider to prove its system is secure and only used for a stated purpose. The network operator can then charge a lower rate for this application but charge a higher rate for non-approved applications. Thus there is no physical restriction on the data that a user can transmit, but there is an incentive to use the approved systems. If the billing rate is significantly reduced when a specified application is used, users will be encouraged to use that application. The discount can be set such that the application provider may make its own charges for use of the application (for instance to cover royalty payments to the owners of the information content being transferred) without the total cost to the end user exceeding the higher tariff.

This invention does not prevent unauthorised use of material over unsupervised peer-to-peer connections, but it makes it uneconomic to do so as it can only be done at greater expense than the authorised process. This charging-based approach should ensure that authorised content sharing applications are used, instead of illegal ones that aim to trade content without the permission of the owners of the inteklkectual property rights in that content. There will always be some degree of illegal file swapping, but if it is made more expensive or very slow, its use should significantly diminish.

Many legal peer-to-peer connections do not require the use of specialised applications, and it would not be appropriate to charge the higher tariff in such cases. However, most such connections do not require the high bandwidths necessary for transferring information-rich content such as motion pictures. For this reason, in a preferred arrangement, a first, lowest, bandwidth is not subject to such differential rates, but is available at a very low tariff. Illegal file-swapping would be theoretically possible at such low rates, but users would be discouraged from doing so by the length of time taken. Narrow-band modems would take an unacceptably long time, possibly measured in days, to download a movie from the internet. Many service providers limit the duration of an individual session, and in any case few users would want to keep their communications connection and computing equipment in use, and unavailable for any other purpose, for such a length of time, when in most cases it would be quicker and more convenient to use a legal alternative such as rental of the a video.

It would be possible to levy a flat rate royalty on all use of this system, for distribution to copyright owners according to some predetermined formula. However, similar royalty-pooling schemes, for example for the use of books in public lending libraries, have been difficult to administer and rely on underlying assumptions of user habits which are difficult to verify. The present invention allows monitoring of the actual use made of copyright material shared over the computer network, and thus a distribution of revenue in proportion to the use made of different material.

The end users of the peer-to-peer system would identify any copyright material they make available using the system, so that the correct payments may be made. To prevent a user falsely claiming that a file attracts no such payment, in order to avoid being charged extra for the content value, users of the central application server may be required to operate under programming that allows the controlling system in the central server to monitor the activities of the end users. This programme would be downloaded from the central application server, and may have security measures such as private keys so that the complete system can only work under control of the central server that generates the service usage records.

It is important when charging for a service to ensure that it is of the right quality. With a peer-to-peer system it is particularly difficult to ensure that the content is what the user really wanted and was prepared to pay for. Possible difficulties include the provision of “bootleg” versions of a film (or a completely different film) instead of the one requested, malicious modification of a film, such as inserting pornographic material in the middle of a children's film, or even trying to spread electronic viruses. The client application can do some checking, such as to ensure that a file claiming to be an audio file is indeed an audio file and not, for example, a video file, and can check that the file is of the expected duration. However, it would not be cost-effective to check all content before it is put on the system, as that may cost the service provider almost as much as making the content available by digitising the contents itself. Instead, a system monitored by the users themselves may be provided, in which a user who has watched a film is asked to rate it according to quality and other parameters. Search results would indicate the ratings previous viewers gave to each version, and highlight any concerns. The cost of accessing a file may then be adjusted in the light of these comments. Once a number of approvals have been made, a “snapshot” sample of the file could be taken by the service provider, to allow the system to compare downloaded files with the stored sample and thereby ensure that it has not been changed to a higher value or corrupted version.

Thus if quality checking is devolved to end users, with a refund mechanism in the event of dissatisfaction, the peer-to-peer high content network could virtually run itself.

An embodiment of the invention will now be described, by way of example, with reference to the Figure, which illustrates schematically the various devices which co-operate in the performance of the invention.

Two end users 1, 2 are shown connected to a network 3. A peer-to-peer control system 4 is provided, through which peer-to-peer connections between the users 1,2 may be controlled. This is an “indexed” system as described above. The controller is arranged to run one or more data applications. The users 1, 2 may nevertheless choose to operate on a “pure” peer-to-peer basis if they wish, although the invention is designed to discourage such use.

The end users 1, 2 of the peer-to-peer system may download approved software from the central application server 4, this software having security measures such as private keys so that the controlling system in the central server 4 can monitor the activities of the end users 1,2, and charge them accordingly.

A billing apparatus 5, 6, 7 is associated with the network 3. This billing apparatus comprises a network call record apparatus 5, which records the use made by each user of the bandwidth-on-demand network, and a service call record apparatus 6, recording the use made of the peer-to-peer controller 4. The two record apparatuses 5, 6 both provide inputs to a billing engine 7 which calculates the cost of use of the systems according to a predetermined tariff, and controls an invoice generator 8 for generating invoices for transmission to the users to request payment for use of the service. It also has an interface with an accounting system 9 of a value-add service available using the controller 4.

The monitoring function of the controller 4 ensures that users do not abuse the system by incorrectly claiming a file has no value in order to avoid being charged extra for the content value when it is in fact copyrighted and valuable. Thus any royalty or other payments due can then be identified by the server 4 and recorded by the service call record system 6. Value-add payments, such as royalties for copying copyright works, may be added to the user bills generated by the billing engine 7 by input from the service call record system 6, the revenue calculated being credited to the accounting system of the value add service 9. Alternatively, the value add accounting system 9 may generate a separate invoice to the end user 1, 2 for such payments.

The embodiment to be described is based on the ATM/ADSL network. This is because there is a bandwidth-on-demand capability available (but not offered as a service), on one type of ADSL Multiplexor (DSLAM) and standard Microsoft Windows™ software can be written to use this capability. A full description of the network will be given later, but first we will consider the service from the end-user's perspective.

Assume the basic “always-on” service offered is 256 kb/s (kilobit/second) downstream (from the network to the user) and 128 kb/s upstream. (Note that most existing services operate at sightly higher speeds). Therefore to download a 650 MB (megabyte) movie from another user having the same 128 kb/s upstream capability over the always-on IP connection would take:
650 MB×1024 (to kByte)×8 (to kbit)/128 kb/s=41,600 secs=over 11.5 hours

An assymmetric bandwidth-on-demand connection, able to take full advantage of bandwidth available for users near the exchange, could operate at upto 5 Mb/s downstream/512 kb/s upstream. To download from this user if there was no congestion, users could receive the file at 512 kb/s. This will result in the download taking less than 3 hours. If it was a two hour movie, the user could start watching it after a short delay to accumulate a buffer, so it would be almost as quick as a video-on-demand service. The time is further reduced if upstream connections are available with higher bit rates, for example SDSL will provide 1.8 Mb/s bi-directionally.

To summarise, using a bandwidth-on-demand peer-to-peer application the following choices would be available to a user for downloading a movie from another user:

| | | Time (to download | Cost for |
|---|---|---|---|
| | Description | 650 MB movie) | movie |
| 1 | Download over the always- | 12 hours (assume | Low/Free |
| | on IP connection, using | other user has 128 kb/s | |
| | peer-to-peer software. | upstream connection) | |
| 2 | Download over a high | 3 hours (assume other | Medium, split |
| | bandwidth Virtual | user has 512 kb/s | between |
| | Connection, set up via | upstream connection) | Telco and |
| | authorised peer-to-peer | | content |
| | software. | | owner. |
| 3 | Download over a high | 20 minutes (assume | High, split |
| | bandwidth Guaranteed | 2 Mb/s connection | between |
| | Virtual Connection, set up | for SDSL user) | Telco and |
| | via authorised peer- | | content |
| | to-peer software. | | owner. |

The controller 4 offers the user 1 a number of files which may be downloaded from other users over the system, giving details for each file of the content, special features such as foreign language soundtrack or subtitles, and other chracteristics such as the quality of the file as assessed by previous users, as will be discussed. When a user selects a file from the controller 4, download options will then be offered depending upon which network capabilities are available and the upstream speed of the peer holding that file. An “Internet” option will always be available as it is based on the ubiquitous IP protocol. A “Shortcut” button indicates that this film can be downloaded from a peer on the same ATM access network. In the example above there is one peer with the desired content and an upstream connection of 512 kb/s (Option 2) and another with 2 Mb/s upstream (Option 3).

When the user opts to download content at the standard slow rate it is carried over the user's permanent virtual circuit at the maximum rate that permits, 128 kbit/s in our example. When the user opts to download content over a high-speed connection a switched virtual circuit (SVC) is established between the peers. Both peers must subscribe to the broadband Internet on the same ATM access network so as to take advantage of the SVC capabilities. In this case, the network uses ATM, a connection-oriented protocol, as well as UNI (User-Network Interface) signalling, to set a route between the two users. The billing for usage is done by one of two options dependent upon what type of bandwidth-on-demand network is used. With the ATM SVC network, every time a high bandwidth connection is established by a user 1, 2 the signalling message to set up the connection is logged by the call record apparatus 5 and when the connection is released a call record is generated that contains the duration of the connection, how much bandwidth was provided and its traffic type.

This call record is then sent to the billing engine 7 which calculates what the actual charge should be and adds it to the user's bill 8. For example a user making a 1 hour call at 2 Mb/s could be charged at 2p a minute, so the user would get a bill for £1.20. Another user, making a 30 minute call at 4 Mb/s could be charged at 4p a minute, so he would also get a bill for £1.20. This reflects the equivalence of the use they have made of the network. (Both users have used 7.2 Gb of capacity, and have paid 16.7p per Gigabit).

For an IP bandwidth-on-demand network the number of packets of each priority are counted in the router 3. The packet counts would then be converted to the equivalent of a usage record by the record apparatus 5 and sent to the billing engine 7 for calculation of the end user bill.

The billing engine 7 is arranged to make the cost of high bandwidth connections very expensive by default, so it is not worthwhile for users to write their own software to use the bandwidth-on-demand capability to download a movie. However, access made using software approved by the network operator can be charged at a different (lower) rate, perhaps also passing some revenue onto third parties such as copyright owners. The peer-to-peer application described here would use the directory server 4 of the peer-to-peer controller 4 to generate a set of download records 6 (service calls) which would be compared in the billing engine 7 with network call records generated by the call record apparatus 5 to produce a realistic charge for network use.

The call record apparatus 5 generates call or usage records that details every on-demand high-bandwidth connection. These are sent to the billing engine 7. The peer-to-peer server 4 generates service records 6 for every valid download made via its software. These are also sent to the billing engine 7. The billing engine 7 runs an algorithm that looks for matched call records. If it finds a match, the end user bill 8 is be reduced to the lower rate, which includes an element for the content owner 9. If no match is found the end user is charged the default high amount. This is in effect a premium rate number network operating in reverse: every call is expensive unless to an approved location or made uisng approved software.

This system is applicable to other services as well as peer-to-peer applications. For example a video conferencing server would act as a central point for control of video conference calls and generate records appropriately. The server could even act as a gateway connecting small bandwidth-on-demand networks together over the wide area,

Other applications where quality of service is beneficial include conventional VoD servers, games servers, TV streaming and even interactive shopping sites which wish to differentiate themselves by providing a more graphical interactive site that requires a bandwidth boost. If these are accessed through an approved server 4 appropriate billing can be imposed, with the revenue divided accordingly. If a “pure” peer-to-peer connection is attempted, i.e. one not managed by an approved server, the high rate is imposed by the billing engine 7.

When the end user 1 has watched a film the controller 4 transmits a request for the user to rate it according to various factors such as video and audio quality, lack of breaks and most importantly whether it is what it purported to be. The ratings and comments returned by the users 1,2 are collated and the results displayed by the controller 4 when subsequent searches call up the same file. The controller 4 may adjust the cost of accessing a file in the light of these comments. The controller 4 may alert a human supervisor to misuse of the rating system, for example a user 2 who gives everything anomalously low ratings (compared with those given by other users) to reduce the cost of the service.

To ensure that a file is what it puroprts to be, the controller 4 may take a sample “snapshot” of each file when it is first offered by a user on the system, to allow the controller 4 to compare the stored sample with each subsequent download of the file from a user 1. It is thus possible to ensure that the user 1 is not abusing the system by disguising a higher-value file or a corrupted version as a previously-approved one. The “snapshot” would be a small file storing a number of bytes selected at random throughout the video file: this short file could be stored on the central server as a master file, and the client application would check its copy against this. If the match fails the file is not offered on the server.

If quality checking is devolved to end users, with a refund mechanism in the event of dissatisfaction, the peer-to-peer high content network could virtually run itself. This system could be the best way of getting content that is gathering dust on people's shelves in the form of video cassettes or even cine film into a more useable digital format. That such content still exists is demonstrated by the success of the BBC in retrieving long-lost radio and TV programmes after appeals to the general public.

1-39. (canceled)

40. Apparatus for loging the use of a bandwidth-on-demand network, comprising first recording means for recording connections established on the network, an application server controlling use of a specified application, the application server having second recording means for recording calls made on the network using that application, and a logging device for receiving inputs from the first and second recording means, and generating an output according to said inputs, wherein means are provided to make connections available at a plurality of bandwidths, the apparatus being arranged to generate different outputs at different bandwidths.

41. Apparatus according to claim 40, wherein the second recording means comprises means to receive information transmitted to the application server by the end users and to generate an output according to said inputs.

42. Apparatus according to claim 41, wherein the application server has means for loging the activities of the end users and the information provided by the end users, and generating an output accordingly.

43. Apparatus according to claim 42, wherein the application server comprises means for interacting with end users such that the application server can log the activities of the end users.

44. Apparatus according to claim 40, wherein the apparatus generates billing information according to the inputs from the recording means.

45. Apparatus according to claim 40 wherein the application server is a peer-to-peer file transfer controller.

46. Apparatus according to claim 45, wherein the controller has means for recording user inputs relating to the quality of files available for transfer.

47. Apparatus according to claim 46, comprising means for adjusting the output according to the rated quality of the information accessed.

48. A telecommunications connection process for a bandwidth-on-demand network, wherein connections are made available at a first bandwidth and one or more higher bandwidths, and a billing process is applied to connections established at the higher bandwidths but not at the first bandwidth, wherein the billing process records connections established on the network, and an application server controlling use of a specified application also records calls made on the network using that application, and an output is generated according to which connections make use of that application.

49. A process according to claim 48, wherein the output is a charge to be made for the use of the network.

50. A process according to claim 49, wherein a charge is also made to a second account when a connection is made making use of the said application server.

51. A process according to claim 59, wherein the charges to be made to the second account are determined by the information transmitted to the application server by the end users.

52. A process according to claim 48, wherein the application server logs the activities of the end users and the information provided by the end users to determine the output to be generated.

53. A process according to claim 48, wherein the end users interact with the application server such that the application server can log the activities of the end users.

54. A process according to claim 48, wherein the application server is a peer-to-peer file transfer controller.

55. A process according to claim 54, wherein the controller has means for recording user inputs relating to the quality of files available for transfer.

56. A process according to claim 55, wherein the outputs are adjusted according to the rated quality of the information accessed.

57. A billing process for a bandwidth-on-demand network, wherein a billing system records connections established on the network, and an application server controlling use of a specified application also records calls made on the network using that application, and instructs a billing engine which connections made use of that application, and wherein such calls are charged by the billing engine at different rates according to whether those connections make use of that application, wherein connections are made available at a first low-bandwidth connection, and the billing process is only applied to connections established at higher bandwidths.

58. A process according to claim 57, wherein connections making use of the application are charged at a lower rate than other connections.

59. A process according to claim 57, wherein a charge is also made to a second account when a connection is made making use of the said application server.

60. A process according to claim 59, wherein the charges to be made to the second account are determined by the information transmitted to the application server by the end users.

61. A process according to claim 60, wherein the application server logs the activities of the end users and the information provided by the end users to determine the charges to be made to the second account.

62. A process according to claim 60, wherein the end users interact with the central application server using programming information having security measures to allow the central server to log the activities of the end users.

63. A process according to claim 57, wherein the application server is a peer-to-peer file transfer controller.

64. A process according to claim 63, wherein the controller has means for recording user inputs relating to the quality of files available for transfer.

65. A process according to claim 64, wherein the call charges are adjusted according to the rated quality of the information accessed.

66. A billing system for a bandwidth-on-demand network, comprising first recording means for recording connections established on the network, an application server controlling use of a specified application, the application server having second recording means for recording calls made on the network using that application, and a billing engine for receiving inputs from the first and second recording means, and for generating charges for calls at different rates according to said inputs, wherein means are provided to make connections available at a plurality of bandwidths, the billing system being arranged to charge different rates at different bandwidths.

67. A billing system according to claim 66, wherein the second recording means comprises means to receive information transmitted to the application server by the end users and to generate charges according to said inputs.

68. A billing system according to claim 67, wherein the application server has means for loging the activities of the end users and the information provided by the end users to determine the charges to be made.

69. A billing system according to claim 68, wherein the central application server comprises means for interacting with end users using programming information having means to allow the central server to log the activities of the end users.

70. A billing system according to claim 66, comprising an interface with a further billing system for transferring accounting information to the further billing system.

71. A system according to claim 70, wherein one of the said rates is zero.

72. A system according to claim 66, wherein the application server is a peer-to-peer file transfer controller.

73. A system according to claim 72, wherein the controller has means for recording user inputs relating to the quality of files available for transfer.

74. A system according to claim 73, comprising means for adjusting call charges according to the rated quality of the information accessed.
